(19) United States
(12) Patent Application Publication
(10) Pub. No.: US 2007/0192994 A1
(43) Pub. Date: Aug. 23, 2007

(54) Sheath type hinge

(76) Inventor: Wei-Chieh Chuang, Hsin Chang City (TW)

Correspondence Address: TROXELL LAW OFFICE PLLC;ONE SKYLINE PLACE, SUITE 1404, 5205 LEESBURG PIKE, FALLS CHURCH, VA, 22041, US

(21) Appl. No.: 11/524,962

(22) Filed: Sep. 22, 2006

(30) Foreign Application Priority Data
Feb. 22, 2006 (TW) 095202986

(51) Int. Cl. E05D 11/08

(52) U.S. Cl. 16/342

(57) ABSTRACT

The present invention discloses a sheath type hinge, comprising a movable part with one end disposed with a jointing portion and the other end extending to form an axle; a fixed part with one end disposed with a connecting portion and a sleeve on the other end manufactured to form an axial bore; and two arch-shape springs formed by stamping metal slices and disposed face to face, which are slantingly bended on both ends to form a contact face, respectively, to be abutted against each other with their edges and are socketingly inserted into the axial bore for positioning; the axle is socketingly inserted into the polygonal space encompassed by the two arch-shape springs and their respective bend portion expends to press against the inner wall of the axial bore and thus absorb the deformation energy such that a friction torque is generated between the respective contact faces and the axle.

### FIELD OF THE INVENTION

The present invention relates to a sheath type hinge and, in particular to a sheath type hinge in which two face-to-face disposed springs are socketingly inserted into the fixed part to further fasten the movable part between the two springs so as to obtain the expected radial frictional torque.

### BACKGROUND OF THE INVENTION

Consumer electronics with flip covers, such as portable computer, electronic dictionary, portable audio/video player, flip mobile phone, generally have a main body on the bottom, which is pivotally connected with the cover body on the top, such that the cover body may swing open or close with respect to the main body. Consequently, the hinge is key to the quality of the products described above.

In general, high precision is required for a conventional sheath type hinge to achieve arresting and positioning functions; a female connection member is fabricated to form an axial bore and a male connection member is horizontally fabricated to form a cut groove to provide the axle with some extent of flexibility and to facilitate the insertion into the axial bore, such that a frictional torque may be generated between the axle and the axle hole. Since the existence of the aforementioned cut groove, the frictional part of the axle and the axial bore is located between two ends of the cut groove along the perpendicular direction. With repetitive operations, the frictional part wears rapidly, leading to a loose contact.

Consequently, the applicant has attempted to overcome the aforementioned drawbacks of the sheath type hinge. In ROC Patent Number 313,274, titled as “Improved Structure of Computer Hinge,” a relay ring is placed between the male connection member and the female connection member, such that the frictional torque generated between the contact face between the male connection member and the relay ring. Also, the male and female connection members are prevented from separating by the interaction of the relay ring with the rod end outside the male connection member and a ladder ring in the axial bore of the female connection member. However, the relay ring is an integrally formed elastic body with a winding and folding shape. Although it can be produced by continuous stamping, the folding angle is difficult to control and thus defective products are prone to be resulted. Consequently, the manufacturing process is complicated and the cost is high. Therefore, it is necessary to provide a new design to overcome the aforementioned drawbacks.

### SUMMARY OF THE INVENTION

To meet such a demand, the applicant having a long time experience in designing, production, and marketing of hinges proposes the present invention, a sheath type hinge, as a result of numerous trials and experiments.

An object of the present invention is to provide a sheath type hinge, comprising a movable part with one end disposed with a jointing portion and the other end extending to form an axle; a fixed part with one end disposed with a connecting portion and a sleeve on the other end manufactured to form an axial bore; and two arch-shape springs formed by stamping metal slices and disposed face to face, which are slantingly bended on both ends to form a contact face, respectively, to be abutted against each other with their edges and are socketingly inserted into the axial bore for positioning; the axle is socketingly inserted into the polygonal space encompassed by the two arch-shape springs and their respective bend portion expends to press against the inner wall of the axial bore and thus absorb the deformation energy such that a friction torque is generated between the respective contact faces and the axle.

Another object of the present invention is to provide a sheath type hinge, wherein the jointing portion of the movable part or the connecting portion of the fixed part has at least a jointing hole or connecting hole, respectively; also, the jointing portion of the movable part or the connecting portion of the fixed part is a single- or double-milled face, or a polyhedron.

Yet another object of the present invention is to provide a sheath type hinge, wherein the folding angle of the bend portion between two adjacent contact faces is 60 degrees.

Still yet another object of object the present invention is to provide a sheath type hinge, wherein one side edge of the arch-shape spring is disposed with an indicator slot.

Still another object of the present invention is to provide a sheath type hinge, the two end edges of the arch-shape spring are slant cut sides or straight cut sides.

### BRIEF DESCRIPTION OF THE DRAWINGS

The present invention can be more fully understood by reference to the following description and accompanying drawings, in which:

FIG. 1 schematically illustrates the exploded perspective view of the sheath type hinge according to the present invention;

FIG. 2 schematically illustrates the sectional assembly view of the sheath type hinge according to the present invention;

FIG. 3 schematically illustrates the cross-sectional view taken along line A-A in FIG. 2;

FIG. 4 schematically illustrates the top view and side view of the spring according to the present invention; and

FIG. 5 schematically illustrates the top view and side view of the spring according to another embodiment of the present invention.

### DETAILED DESCRIPTION OF THE INVENTION

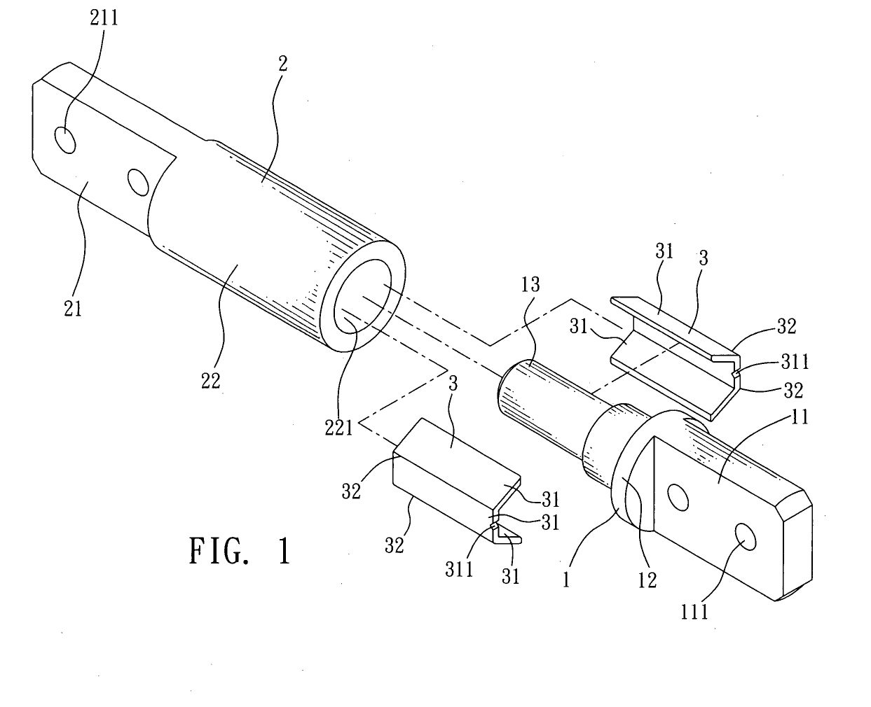

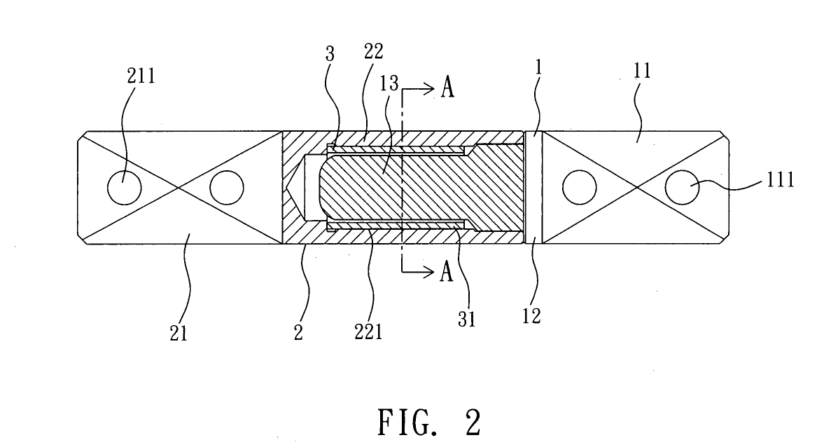

With reference to FIGS. 1 to 4, the sheath type hinge according to the present invention comprises a movable part 1, a fixed part 2, and a pair of arch-shape springs 3, wherein the “movable” and “fixed” do not restrict the movement of the two elements; when the present invention is being operated, the movable part 1 can be in fixed condition and the fixed part 2 can be in a rotating movement.

The movable part 1 is a shaft with one end connected to an object, a cover body for example. The jointing portion 11 as shown in the figures has at least a jointing hole 111, which is fastened onto an object by a conventional fastening device, a screw for example. Furthermore, the jointing portion can be, for example but not limited to, a milled face polyhedron, which, in practice, may be a single- or double-milled face polyhedron, a triangular, a rectangular polyhedron and so on, such that it can be fittingly inserted into and positioned on an object.

The jointing portion 11 is disposed with a collar 12 therein to abut against the fixed part when socketingly connected together and the collar 12 axially extends to form an axle 13, which is a conventional art and will not be discussed here furthermore.

The fixed part 2 is also a shaft with a connecting portion 21 on one end to be connected to another object, a main body for example. The connecting portion 21 as shown in the figures has at least a connecting hole 211, which is fastened onto another object by a conventional fastening device, a screw for example. Furthermore, the connecting portion 21 can be, for example but not limited to, a milled face polyhedron, which, in practice, may be a single- or double-milled face polyhedron, a triangular, a rectangular polyhedron and so on, such that it can be fittingly inserted into and positioned on an object.

The other side of the sleeve 22 of the fixed part 2 is axially manufactured to form an axial bore 221, which is a conventional art and will not discussed here furthermore.

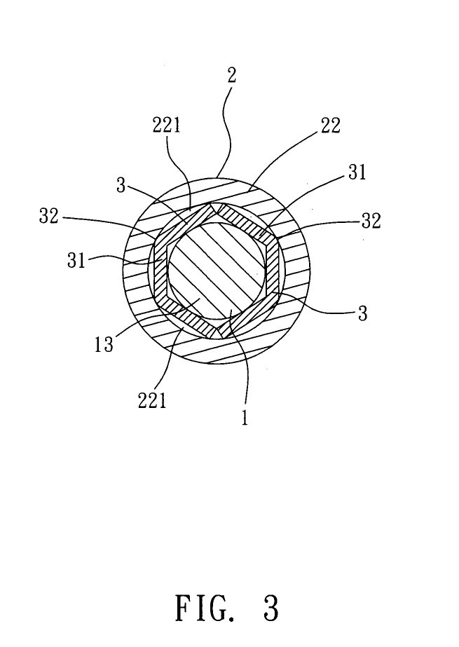

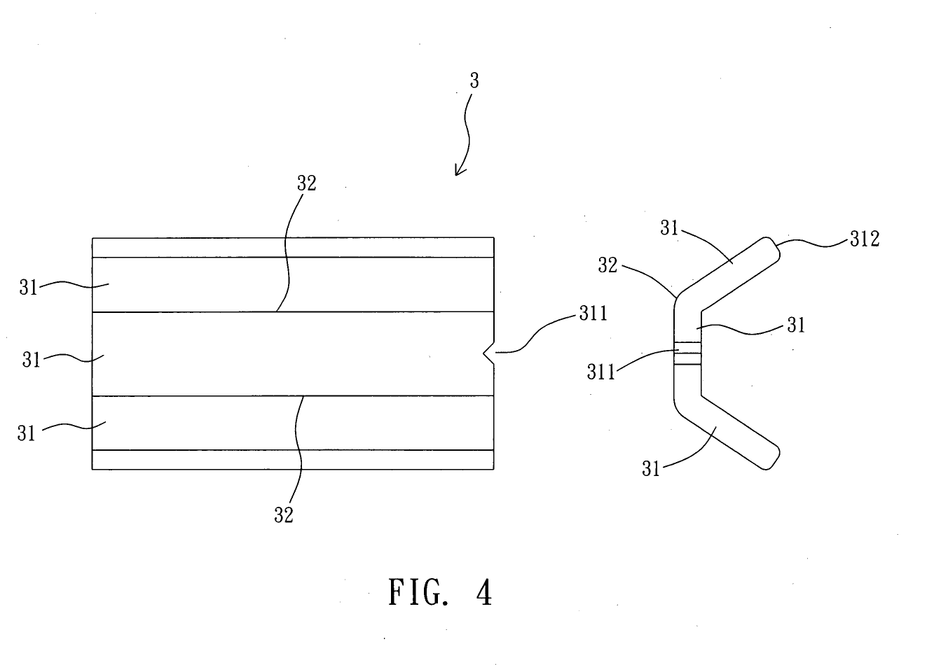

A shown in FIG. 4, the arch-shape spring 3 is formed by stamping a metal plate into a trapezoid slice, whose two bend portions 32 on either side of the contact face 31 extend to form a respective contact faces 31, i.e. the folding angle of the bend portion between two adjacent contact faces is 60 degrees. When the present invention is being assembled, the two edges of the two arch-shape springs 3 are abutted against each other and fittingly inserted into the axial bore 221. Then, the axle 31 is fittingly inserted in a close fit into the hexagonal space encompassed by the two arch-shape springs 3, in which the bend portions 32 radially expand to tightly abut against the interior wall of the axial bore 221, so as to form a fixed condition as shown in FIG. 3 and further to become a hinge with the function arresting and positioning. Furthermore, to enhance the directionality of the arch-shape spring 3 during assembling, the side edge of the arch-shape spring 3 can be cut to form a indicator slot 311, a V-shape slot for example, Thus, the stamped arch-shape springs 3 with the same direction and bending are assembled in the axial bore 211 to increase the convenience of the assembly operation.

Consequently, the movable part 1, the fixed part 2, and the arch-shape spring 3 are assembled according to the aforementioned description to form the sheath type connection. When the movable part 1 rotates relative to the movable part 2, the inner wall of the axial bore 221 generates a radial pressure on the respective bend portions 32 of the two arch-shape springs 3 and the ring-like body absorbs the deformation to ensure the frictional torque in the hinge generated between the contact faces between the contact faces 31 and the axle 13.

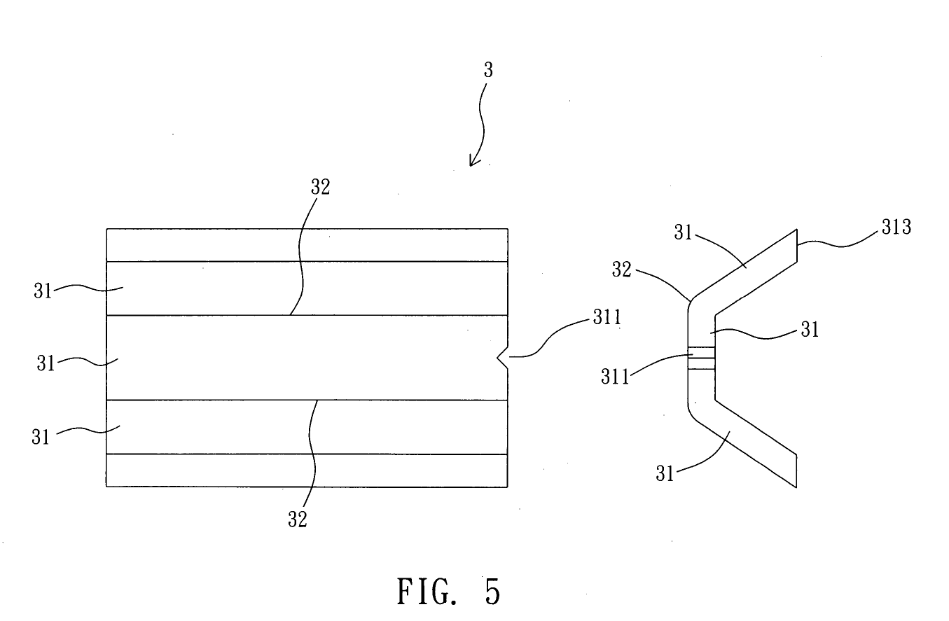

FIG. 5 shows another embodiment of the arch-shape spring 3. Its difference with respective to the first embodiment lies in the fact that both edge sides, i.e. bend portions, of the present arch-shape spring 3 are straight cut sides 313, rather than the slant cut sides 312 in the first embodiment.

By putting the present invention into practice, the movable part, fixed part, and arch-shape spring can provide radial friction after are being assembled. Furthermore, the two arch-shape springs capable of forming a polyhedron space can be manufactured by the stamping process alone, which can ensure a stable angle between the bend portions and thus low cost and high yield rate. The arch-shape spring according to the present invention perform far better than the relay ring made of integrally formed elastic body with a winding and folding shape.

While the invention has been described with reference to the a preferred embodiment thereof, it is to be understood that modifications or variations may be easily made without departing from the spirit of this invention, which is defined by the appended claims.

What is claimed is:

1. A sheath type hinge, comprising
a movable part with one end disposed with a jointing portion and the other end extending to form an axle;
a fixed part with one end disposed with a connecting portion and a sleeve on the other end manufactured to form an axial bore; and
two arch-shape springs formed by stamping metal slices and disposed face to face, which are slantingly bended on both ends to form a contact face, respectively, to be abutted against each other with their edges and are socketingly inserted into the axial bore for positioning;
the axle is socketingly inserted into the polygonal space encompassed by the two arch-shape springs and their respective bend portion expends to press against the inner wall of the axial bore and thus absorb the deformation energy such that a friction torque is generated between the respective contact faces and the axle.

2. The sheath type hinge as defined in claim 1, wherein the jointing portion of the movable part or the connecting portion of the fixed part has at least a jointing hole or connecting hole, respectively

3. The sheath type hinge as defined in claim 1, wherein the jointing portion of the movable part or the connecting portion of the fixed part is a single- or double-milled face, or a polyhedron.

4. The sheath type hinge as defined in claim 1, wherein the folding angle of the bend portion between two adjacent contact faces is 60 degrees.

5. The sheath type hinge as defined in claim 1, wherein one side edge of the arch-shape spring is disposed with an indicator slot.

6. The sheath type hinge as defined in claim 1, wherein the two end edges of the arch-shape spring are straight cut sides.

7. The sheath type hinge as defined in claim 1, wherein the two end edges of the arch-shape spring are slant cut sides.
